(19) United States
(12) Patent Application Publication
(10) Pub. No.: US 2005/0259635 A1
(43) Pub. Date: Nov. 24, 2005

(54) Method for forwarding signalling messages and corresponding components

(76) Inventors: Bruno Bozionek, Borchen (DE); Dieter Hemkemeyer, Olde (DE); Rainer Zimmermann, Paderborn (DE)

Correspondence Address: Siemens Corporation;Intellectual Property Department, 170 Wood Avenue South, Iselin, NJ, 08830, US

(21) Appl. No.: 10/525,778

(22) PCT Filed: Aug. 11, 2003
(86) PCT No.: PCT/DE03/02698

§ 371 Date: Feb. 28, 2005

(30) Foreign Application Priority Data
Sep. 5, 2002 (DE) 10241197.2

(51) Int. Cl. H04L 12/66

(52) U.S. Cl. 370/352

(57) ABSTRACT

The invention relates to a method, whereby the decision as to whether a protocol conversion is required or not is made according to a target datum contained in a signaling message, it is decided whether. The generation of a signaling message according to another signaling protocol is only then carried out if it is absolutely necessary. Said measures enable data losses to be limited as a result of the protocol conversion. Furthermore, for example, the load on the protocol conversion unit is reduced.

### CROSS REFERENCE TO RELATED APPLICATIONS

This application is the US National Stage of International Application No. PCT/DE03/02698, filed Aug. 11, 2003 and claims the benefit thereof. The International Application claims the benefits of German application No. 10241197.2 DE filed Sep. 5, 2002, both of the applications are incorporated by reference herein in their entirety.

### FIELD OF INVENTION

The invention relates to a method, whereby signaling messages are received, which in each case contain a target datum. The target datum specifies a target device to which the signaling message is to be forwarded. Alternatively, the target datum allows the determination of a target device to which the signaling message is to be forwarded.

### BACKGROUND OF INVENTION

The signaling messages are transferred over a data transfer network according to various signaling protocols. The data transfer network is, for example, a data packet transfer network or a data transfer network, by which the data are transferred in time slots.

The signaling relates in particular to instructions for the exchange of information, which relates to setting up, taking down and controlling a connection. At the same time, for example, the connection exists only at higher protocol levels, while the transfer of the operating data and the signaling data is connectionless at lower protocol levels. Another type of signaling messages are, for example, messages with which the connection status of a device is signaled to another device, without an operating data transfer connection to another device being required to exist.

A signaling protocol is the body of control methods and operating instructions, according to which the signaling between two or more functional units working together is carried out. The protocols are customarily defined for a particular interface. All protocols of a communication connection form a so-called protocol stack.

An interface is the junction between two systems and is defined at a logical or a physical level. Thus there is, for example, an interface between various telecommunication devices or interfaces for the connection of subscriber terminal equipment.

If signaling messages are received according to various signaling protocols, then it would be possible to first convert the signaling messages into internal signaling messages that conform to a general signaling protocol in a central communication device for ensuring a unified processing of the signaling messages. The general signaling protocol would then have to include the superset of all necessary information elements. After the central processing of the signaling message, this would then be converted into a signaling message according to a signaling protocol of the target device.

### SUMMARY OF INVENTION

An object of the invention is to show a simple method for the forwarding of signaling messages, which in particular prevents data loss, which in particular can be carried out with a low device-related expense, and which in particular can be quickly implemented. Furthermore, a related program and a related device should be specified.

The object related to the method is achieved by means of the method steps specified in the claims. Developments are specified in the dependent claims.

The invention is based on the consideration that a conversion of signaling messages according to a signaling protocol into signaling messages according to another signaling protocol should then only be carried out if this is also absolutely unavoidable. Electronic circuits or processors are thus necessary for the conversion only for a portion of the signaling messages to be forwarded. Losses of data occur for many conversions, because a specific signaling message according to one signaling protocol cannot be converted into a signaling message with the same purpose according to the other signaling protocol. For the method according to the invention, these transformation errors occur only for a portion of the signaling messages to be forwarded.

A converted signaling message is produced and forwarded for the method according to the invention in each case, depending on the target datum for signaling messages with a target datum, which specifies or relates to a target, which requires a protocol conversion. The converted signaling message is produced according to another signaling protocol as the signaling protocol of the received signaling message, taking into account the specifications for the conversion of the signaling messages from one signaling protocol into signaling messages of the other signaling protocol. In addition, the signaling messages are forwarded without conversion to another signaling protocol, depending on the target datum for signaling messages with a target datum, which specifies or relates to a target device, which does not require a protocol conversion. For an embodiment, without conversion to another signaling protocol also means that no conversion to an internal signaling protocol of the device used for the forwarding is carried out.

Specifications for the conversion of the signaling messages are provided in international standards, for example. At the same time, signaling messages with the same or a similar target according to the target protocol of the conversion are produced, in principle, from signaling messages with a specific signaling target according to the original signaling protocol. Signaling data is customarily placed in different positions in the converted signaling message than in the received signaling message.

For a development of the method according to the invention, the signaling messages are received from a signaling device, which controls the production and forwarding of a converted signaling message and the forwarding without conversion of the signaling protocol. The signaling device receives signaling messages from various communication devices, for example, from telephone terminal equipment, from data processing devices, from servers, from application programs or from network transfer devices between various data transfer networks. Additional central functions are also performed in the signaling device for a development, for example:
the protocol conversion,
the control of the access by terminal devices or central devices of local data transfer networks to a data transfer network, or
central switching tasks or forwarding tasks.

By performing several functions in a signaling device, the functions can be performed in a simpler manner than in functional units physically separated from one another. In particular, no data transfer network is necessary for the communication between the individual functional units for performing the functions.

A particular technical effect is achieved if the signaling units also perform functions of a telecommunication device, in particular switching functions in a telecommunication device network. The configuration expense for several hundred, several thousand or even several tens of thousands of terminal devices in a telecommunication device network is considerable. In the signaling device, this expense is required only once for an embodiment, centrally for all telecommunication devices of the network. If very many telecommunication devices are part of the network, then the configuration can also be stored as distributed into several central signaling devices, whereby however multiple stores of data in different signaling devices are avoided.

If the signaling device performs functions of a telecommunication device, then telecommunication devices that signal according to various signaling protocols to other telecommunication devices can operate in the network. By means of the protocol conversion, signaling can also take place between telecommunication devices, which signal according to different signaling protocols or according to signaling protocols of various protocol families. In particular, the integration of telecommunication devices from various manufacturers into one telecommunication device network is thus made possible.

For another development of the method according to the invention, the signaling device also performs the functions of a network access device for central devices for the provision of services for a multitude of terminal devices of several local data transfer networks. Examples of local data transfer networks are Ethernet networks or so-called token networks, which are optionally connected over so-called bridges or routers.

Signaling data and operating data can thus be exchanged between the central devices of various local data transfer networks with the same and different data transfer methods, or with the same and different signaling methods.

For an alternative development, the network access device contained in the signaling device performs a network access function for terminal devices of one or more local data transfer networks. Terminal devices are connected to the local data transfer network in one embodiment, which signals at higher protocol levels according to various signaling protocols.

At a middle protocol level, the data transfer networks function by an embodiment according to the internet protocol.

For a following development, signaling protocols to be used are:
protocols of the H.323 protocol family of the ITU-T (International Telecommunication Union—Telecommunication Standardization Sector), in particular the protocols H.225, H.245, H.450.x,
the SIP protocol (Session Initiation Protocol) of the IETF (Internet Engineering Task Force),
a signaling protocol for signaling between telecommunication devices, preferably the protocol QSIG. However, other signaling protocols are also used, to the extent that a protocol conversion is possible.

For a following development, the target datum is read with an access function, which reads target data of various signaling protocols. This is possible if the access function determines the signaling protocol of the signaling message beforehand. This is made possible, for example, by the inclusion of data values or data structures typical for the protocol, or with the help of a protocol indicator in the signaling message. The protocol required by the target device specified by the target datum is subsequently determined. The decision about the necessity of a protocol conversion or about forwarding the signaling message without protocol conversion is then made on the basis of a comparison of the original signaling protocol and of the required signaling protocol. It is possible to make this decision in a simple manner by means of these method steps.

For a following development of the method for the forwarding of signaling messages, no protocol conversion is required for signaling protocols of the same protocol family. At the same time, a specific basic protocol and its development, for example, belong to a protocol family.

For a following development, the received signaling message is stored in a storage device. It is then decided whether a protocol conversion is or is not necessary. The stored signaling message is subsequently converted or forwarded without undergoing a protocol conversion. The use of a storage device is a simple means by which to store the signaling message until the decision about a protocol conversion or against a protocol conversion.

For another development, the signaling message relates to signaling for the transfer of voice data or for the performance of an additional service feature with the transfer of voice data. The additional service features specify services that go beyond the simple transfer of voice data, e.g. forwarding of a call, a conference circuit or a call-back when busy. The method according to the development is particularly suited for the transfer of voice data in operating data packets, as is the case with internet telephony, which is also called VoIP (Voice over Internet Protocol).

Furthermore, the invention relates to a program and a device for the implementation of the method according to the invention and its developments. For this reason, the above-named technical effects also apply for the program and for the device.

For one embodiment, the device contains a protocol conversion device, which produces a signaling message with the same or at least similar control characteristics according to another signaling protocol from a signaling message according to a signaling protocol. Devices with such integrated protocol converters therefore function without external signaling network transfer devices or so-called border proxy servers. In this context, one also speaks of a “multi-protocol capability”.

### BRIEF DESCRIPTION OF THE DRAWINGS

Following are exemplary embodiments of the invention explained on the basis of the accompanying drawings. Shown therein:

FIG. 1 a forwarding device and an optional functional protocol conversion device,

FIG. 2 a network access device for servers for several local data transfer networks and a protocol conversion device contained in the network access device,

FIG. 3 a network access device for the terminal devices of a local data transfer network and a protocol conversion device contained in the network access device, and

FIG. 4 method steps of a method for forwarding signaling messages with optional protocol conversion.

### DETAILED DESCRIPTION OF INVENTION

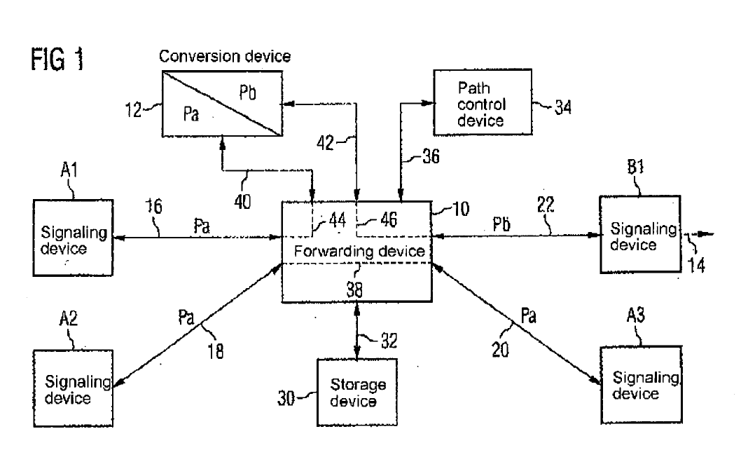

FIG. 1 shows a forwarding device 10 and a protocol conversion device 12 physically separated from it. The forwarding device 10 serves to forward signaling messages, which are sent to and from signaling devices A1, A2, A3 and B1. The signaling devices A1 to A3 and B1 are, for example, terminal devices, devices to which a multitude of terminal devices are connected, or devices that in turn forward the received signaling messages; see arrow 14 for the signaling device B1, for example.

The signaling devices A1 to A3 send or receive signaling messages according to a signaling protocol Pa, which differs from a signaling protocol Pb, according to which the signaling device B1 sends and receives signaling messages. Signaling messages according to the signaling protocols Pa and Pb are exchanged over transfer lines 16 to 22 between the signaling devices A1 to A3 and B1 on the one side and the forwarding device 10 on the other side. The signaling messages according to the signaling protocols Pa and Pb can be converted with the help of the protocol conversion device 12 into corresponding signaling messages of the respective other protocol according to a prespecified transformation instruction.

Furthermore, the forwarding device 10 has access to a storage device 30, see arrow 32, in which received signaling messages can be temporarily stored, until a decision about them has been made as to whether a protocol conversion is or is not necessary. Furthermore, the forwarding device 10, for example, places inquiries with a path control device 34, see arrow 36, in order to determine the signaling unit to which a received signaling message must be forwarded.

If the forwarding device 10 receives, for example, a signaling message from the signaling device A2 at the signaling device A3 over the transfer line 18, then a control device of the forwarding device 10 determines that both signaling devices A2 and A3 signal according to the same signaling protocol. A protocol conversion is therefore not necessary. The signaling message received over the transfer line 18 is therefore forwarded without protocol conversion over the transfer line 20 to the signaling device A3, see dotted line 38. Likewise, signaling messages for the signaling device A2 coming from the signaling device A3 over the transfer line 20 are forwarded without protocol conversion to the signaling device A2.

However, if a signaling message intended for the signaling device B1 is received in the forwarding device 10 from the signaling device A1 over the transfer line 16, then the control device of the forwarding device 10 establishes that the signaling device A1 sending the signaling message and the signaling device B1 receiving the signaling message signal according to different signaling protocols Pa and Pb. Therefore, the control device of the forwarding device 10 automatically incorporates the protocol conversion device 12 into the processing of the received signaling message. The received signaling message is sent from the forwarding device 10 to the protocol conversion device 12 over a transfer line 40, and converted there into a signaling message according to the signaling protocol Pb. The protocol conversion device 12 subsequently sends the converted signaling message back to the forwarding device 10 over a transfer line 42. The forwarding device 10 forwards the converted signaling message to the signaling device B1 by using the path control device 34.

The incorporation of the protocol conversion device 12 into the forwarding is represented within the forwarding device 10 by means of dotted lines 44 and 46. Likewise, signaling messages from the signaling device B1 intended for the signaling device A1 are forwarded according to the signaling protocol Pb from the forwarding device 10 to the conversion device 12, converted there into signaling messages according to signaling protocol Pa, and forwarded to the forwarding device 10 as converted signaling messages. The forwarding device 10 then in turn forwards the converted signaling message to the signaling device A1.

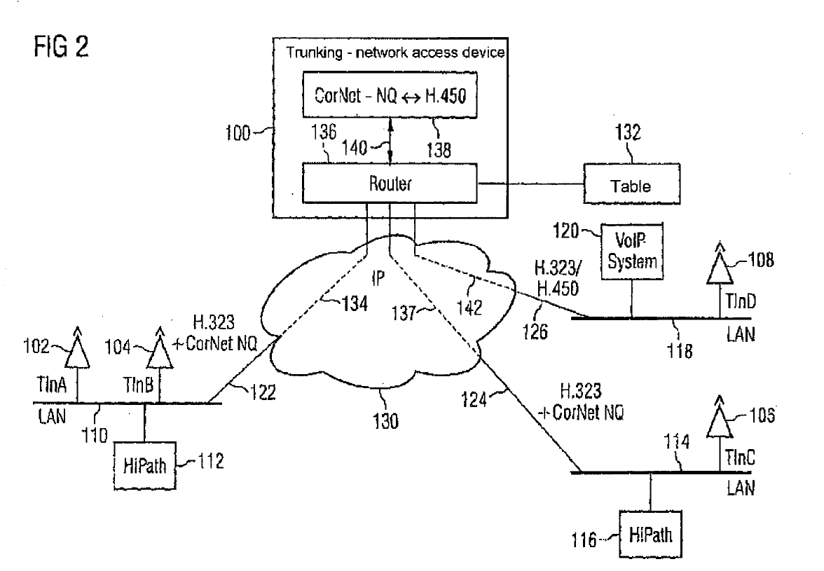

FIG. 2 shows a so-called trunking network access device 100, which is also designated as a gatekeeper and performs the network access functions for servers 112, 116 and 120. The servers 112, 116 and 120 perform services for terminal devices 102, 104, 106 and 108, which in this sequence are arranged as subscribers TlnA, TlnB, TlnC and TlnD.

The terminal devices 102 and 104 are connected to a local data transfer network 110, to which the server 112 is also connected, which performs the functions of a telecommunication device. The terminal device 106 is connected to a local data transfer network 114, for example, an Ethernet. Furthermore, the server 116 is connected to the local data transfer network 114, which performs functions of a telecommunication device for the subscriber TlnC. The terminal device 108 is connected to a local data transfer network 118, to which the server 120 is also connected, which performs the functions of a telecommunication device for the terminal devices of subscriber TlnD connected to the local data transfer network 118.

The local data transfer networks 110, 114 and 118 have, at most, a range less than ten kilometers, typically less than one kilometer and are, for example, placed inside a building. The local data transfer networks 110, 114 and 118 are connected with a wide area network 130 suitable for the transfer of voice data over transfer lines 122, 124 and 126 in this sequence, for example, with the internet functioning according to the internet protocol. The network access device 100 can also be achieved over the wide area network 130. The wide area network 130 serves for data exchange over distances significantly greater than ten kilometers, typically over more than one hundred kilometers.

Along with the network access device 100, the servers 112, 116 and 120 perform the functions of telecommunication device network, which allows the subscribers TlnA to TlnD to call only over call numbers specified in the telecommunication network. For providing the functions of the telecommunication device network, the network access device 100 has access to a storage device 132 in which, on one hand, a table is stored, in which it is recorded which terminal device 102 to 108 is associated with which server 112, 116 or 120. On the other hand, it is also recorded in the table which signaling protocol is used for signaling with the server 112, 116 or 120. In the present exemplary embodiment, both of the servers 112 and 116, for example, have been manufactured by the company SIEMENS AG, such that the signaling is carried out according to an in-house protocol for signaling between switching centers. This protocol is, for example, the protocol CorNetNQ, which is built on the protocol QSIG, which has been standardized by the ETSI (European Telecommunication Standard Institute). The servers 112 and 116 are, for example, of the type HiPath 3000, 4000 or 5000. The server 120 was in contrast manufactured by another company and signals in connection with the functions in the telecommunication device network according to the protocol H.323/H.450 or H.450.x, whereby x is a natural number for the designation of a special standard for a special additional service feature.

In the exemplary embodiment, a signaling protocol of the protocol family H.323 is used, in particular the signaling protocols H.225 or H.245, as a signaling protocol between the servers 112, 116 and 120 on the one side and the network access device 100 on the other side.

Although the signaling according to the protocol family H.323 is explained in detail in the relevant standards, several signaling messages are to be explained in the following in order to be able to better illustrate the relationship to the method according to the invention. It is assumed that the server 112 would like to send a signaling message to the terminal device 106 or to the server 116 responsible for this terminal device. In the server 112 it is not known that the terminal device 106 belongs to the server 116. In addition, the address of the server 116 is not known in the server 112. The server 112 sends an admission request message to the network access device 100, which is confirmed with an admission confirmation message. After this, the server 112 directs a standard setup message according to H.323 to the network access device 100. A CorNetNQ setup message is contained in the H.323 setup message. A so-called tunneling method is spoken of in this context, which is explained in the standard H.323 Annex M.1, for example.

The H.323 setup message is transferred to the network access device 100, see dotted line 134. A control device of the network access device evaluates the H.323 setup message and at the same time establishes that this setup message contains a CorNetNQ message. The control device determines the terminal device specified in the CorNetNQ message or the server 116 specified in this message. Optionally, the sending server 112 or a terminal device 102, 104 originating the signaling message is also determined based on the received signaling message. With the help of the storage device 132, it is then determined that no protocol conversion is necessary for the tunneled signaling message, because the server 116 can process signaling messages according to the signaling protocol CorNetNQ. The network access device 100 forwards an H.323 setup message to the server 116 on this basis. With the help of the tunneling method, the received CorNetNQ message is forwarded unmodified, i.e. directly, to the server 116 in the H.323 setup message without a protocol conversion being carried out, see dotted line 137.

The server 116 receives the H.323 setup message and processes the CorNetNQ message contained in it according to the protocol; at the same time, for example, a signaling button is activated on a display device of the terminal device 106.

However, if the server 112 sends an H.323 setup message with a tunneled CorNetNQ message, i.e. a setup message as well, which relates to the server 120 or the terminal device 108, then it is determined in the network access device 100 that a protocol conversion is necessary for the tunneled signaling message according to the protocol CorNetNQ in a signaling message according to the signaling protocol H.323/H.450. The control device 136 therefore activates a protocol conversion device 138, which converts the CorNetNQ message into an H.323 or H.450 signaling message with the same signaling target, and passes the converted signaling message back to the path control device 136, see double arrow 140.

In the present exemplary embodiment, the path control device 136 sends an H.323 setup message received from the protocol conversion device 138, which has a similar signaling effect to the CorNetNQ message. This message is sent to the server 120, see dotted line 142. The server 120 processes the H.323 setup message and carries out the related control action, for example, activation of a button at the terminal device 108.

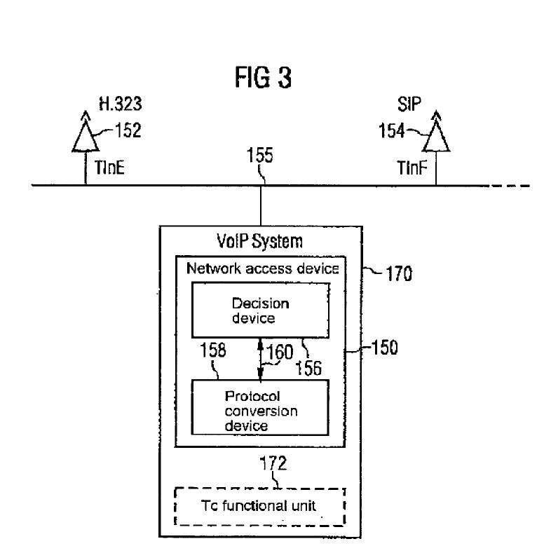

FIG. 3 shows another exemplary embodiment with a network access device 150 for the terminal devices 152, 154 of a local data transfer network 155. The terminal device 152 is used by a subscriber TlnE and signals according to the protocols of the protocol family H.323. The terminal device 154 is used by a subscriber TlnF and signals, for example, according to the protocol SIP. Nevertheless, both terminal devices 152 to 154 can exchange signaling data and operating data, because the network access device 150 also make possible a protocol conversion. For example, the terminal device 152 directs an H.323 setup message to the network access device 150. The terminal device 154 is specified in the H.323 setup message as the target of the message. In order to transmit the H.323 setup message to the network access device 150, an address of the network access device 150 known to the terminal device 152 is for example used for forwarding setup messages.

The network access device 150 contains a decision device 156, which determines whether a protocol conversion is or is not necessary with respect to the received signaling message. In the case of a signaling message from the terminal device 152 to the terminal device 154, a protocol conversion is necessary. Therefore, the decision device 156 includes a protocol conversion device 158, which produces a SIP invite message from the H.323 setup message, see double arrow 160. The network access device 150 then sends the converted signaling message to the terminal device 154. The terminal device 154 answers the network access device 150 according to the SIP protocol. The network access device 150 carries out a protocol conversion for the answer message and forwards the converted answer message to the terminal device 152.

However, if the terminal device 152 sends to the network access device 150 a signaling message that is intended for a terminal device that functions according to the H.323 protocol family, then the decision device 156 makes the decision that a protocol conversion is not necessary. The received signaling message is in this case forwarded to the target terminal device unmodified or in essence unmodified.

For another exemplary embodiment, the network access device 150 is a component of a VoIP system 170, which alongside the network access device 150 contains a telecommunication device functional unit 172, which performs the functions of a telecommunication device. The system 170 performs the functions of an individual telecommunication device or is embedded in a telecommunication device network.

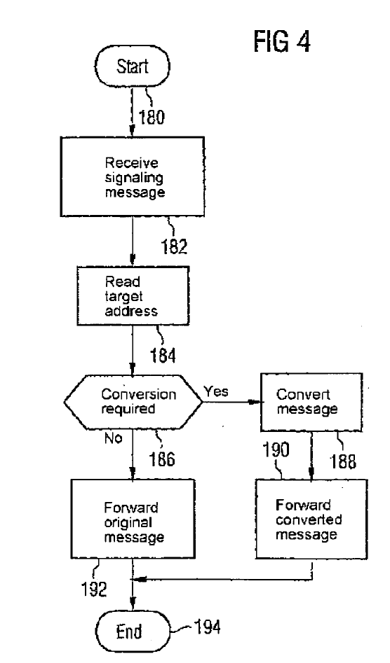

FIG. 4 shows method steps of a method for forwarding signaling messages with optional protocol conversion. The method starts in a method step 180. In a subsequent method step 182, a signaling message according to an original signaling protocol is received.

In a method step 184, a target address is read from the original signaling message or determined on the basis of the information contained in the signaling message. In a method step 186, depending on the target address and, for example, depending on the signaling protocol of the received signaling message, it is tested whether a protocol conversion is necessary. If this is the case, then a method step 188 follows directly after the method step 186, in which the original signaling message is converted into a signaling message according to another signaling protocol. The converted signaling message is subsequently forwarded in a method step 190.

However, if it is determined in method step 186 that a protocol conversion is not necessary, then a method step 192 follows directly after the method step 186.

In method step 192, the original signaling message is forwarded unmodified. The method is ended in a method step 194 both after the method step 192 as well as after the method step 190.

With the involvement of the forwarding device 10, the network access device 100 or the network access device 150, the method steps 180 to 194 are carried out with electronic circuits that contain no microprocessor, or through the execution of program instructions of a program or several programs by means of at least one microprocessor.

Other signaling protocols instead of the mentioned signaling protocols are used for other exemplary embodiments.

1.-12. (canceled)

13. A method for forwarding a signaling message embodied accordance with a first signaling protocol from a first device within a first network to a second device within a second network, comprising:
receiving the signaling message;
connecting the first and second networks by a third network;
providing a network access device in the third network;
transferring the signaling message from the first device to the network access device by tunneling the message through the third network;
determining if the first signal protocol and a second signaling protocol supported by the second device are the same protocol, the determination made by the network access device and based on a target datum identifying the second device;
if the protocols are the same the method further comprising
converting the signaling message into the second signaling protocol,
transferring the converted signaling message to the second device by tunneling the message through the third network; and
if the protocols are not the same the method further comprising
transferring the signaling message to the second device by tunneling the message through the third network.

14. The method according to claim 13, wherein protocol conversion is handled by the network access device.

15. The method according to claim 13, wherein the network access device performs functions of a telecommunication device, which serves for a switching of a connection for a transfer of voice data in a private data transfer network.

16. The method according to claim 13, wherein the network access device switches a connection that transfers voice data in a private data transfer network.

17. The method according to claim 16, wherein a data transfer network functions according to the internet protocol.

18. The method according to claim 13, wherein the network access device performs a network access function for a plurality of terminal devices of a local data network

19. The method according to claim 13, wherein the network access device performs a network access function for a central device of a plurality of local data transfer networks, the central device perform services for a plurality of terminal devices of a data transfer network.

20. The method according to claim 13, wherein a the first and second signaling protocols are selected from the group consisting of SIP, H.323, QSIG, SIP based, H.323 based, QSIG based, and combinations thereof.

21. The method according to claim 13, further comprising:
reading the target datum with an access function that reads target data of various signaling protocols; and
determining the first signaling protocol of the received signaling message;

22. The method according to claim 20, wherein no protocol conversion is required if the first and second signaling protocols are in a same protocol family.

23. The method according to claim 13, further comprising:
storing the first protocol signal in a storage device; and
deciding if a protocol conversion is required after the storage step.

24. The method according to claim 13, wherein the signaling message relates to a transfer of voice data and/or to the performance of additional service features for the transfer of voice data.

25. The method according to claim 24, wherein the transfer of voice data is in an operating data packet.

26. A program for determining if a signaling message embodied accordance with a first signaling protocol supported by a first device requires conversion to a second signaling protocol supported by a second device, comprising:
a receiver for receiving the signaling message;
a target datum identifying the second device and thereby identifying the second signaling protocol;
a comparator that compares the first signaling protocol of the signaling message with the second signaling protocol; and
a converter that converts the signaling message into the second signaling protocol if the comparator indicates the first and second signaling protocols are different.

27. The program according to claim 26, wherein the converter transfers the signaling message to a network access device to do the conversion.

28. The program according to claim 26, further comprising a storage interface that stores the signaling message.

29. The program according to claim 26, further comprising a transferring section that transfers the signaling message to the second device.

30. A network access device for forwarding a signaling message from a first device in a first device in a first network to a second device in a second network, comprising:
a control device for evaluating the signaling message and determining the second terminal device;
a compare device that compares a first signaling protocol of the signaling message received from the first device and a second signaling protocol supported by the second device; and
a transfer device that transfers the signaling message to the second device.

31. The network access device according to claim 30, further comprising an interface that accesses a storage device, the storage device comprising an association between a terminal device and a server as well as an association between a protocol and the server.

32. The network access device according to claim 30, further comprising a conversion device that converts the signaling message embodied according to the first signaling protocol to a second signaling message protocol.
